(19) United States
(12) Patent Application Publication
(10) Pub. No.: US 2016/0094668 A1
(43) Pub. Date: Mar. 31, 2016

(54) METHOD AND APPARATUS FOR DISTRIBUTED CUSTOMIZED DATA PLANE PROCESSING IN A DATA CENTER

(71) Applicant: ALCATEL-LUCENT USA Inc., Murray Hill, NJ (US)

(72) Inventors: Hyunseok Chang, Holmdel, NJ (US); T.V. Lakshman, Morganville, NJ (US); Sarit Mukherjee, Morganville, NJ (US); Limin Wang, Plainsboro, NJ (US)

(73) Assignee: ALCATEL-LUCENT USA Inc., Murray Hill, NJ (US)

(21) Appl. No.: 14/499,326

(22) Filed: Sep. 29, 2014

(51) Int. Cl. H04L 29/08; G06F 9/455

(52) U.S. Cl. CPC H04L 67/16; G06F 9/45558; G06F 2009/45595

(57) ABSTRACT

Systems and methods for providing data plane services in a data center include receiving a request for a data plane service from a tenant of a host in the data center. In response to receiving the request, a service process is instantiated at the host for performing the data plane service for a virtual machine of the tenant.

### BACKGROUND

The present embodiments relate generally to data plane services and more particularly to customized data plane processing in a data center.

Data plane services have been traditionally provided in a data center by provisioning service-specific hardware boxes in a centralized fashion. However, this traditional approach results in a number of drawbacks, including high cost, limited scalability, extra bandwidth consumption due to cross traffic between tenants and data plane services, and delays for data plane services.

In order to provide elasticity and cost effectiveness, the data center should be implemented with a scale out architecture, where the resource requests in a multi-tenant data center scale with the number of hosts in the data center. This ensures that additional resources added to the data center, or additional resource requests from tenants in the data center, do not create bottlenecks within the data center.

One conventional approach provides basic switching and routing functions (i.e., layers 2 and 3 services) in a data center that scale out with the number of hosts and tenants. Another conventional approach provides a scale out, distributed data plane solution for layers 3 and 4 load balancing. In this approach, traffic to the data center is load balanced using hosts. However, this approach is very specific to layers 3 and 4 load balancing and does not provide for any other custom data plane processing. There are no solutions that provide for higher layer (i.e., layers 4-7) packet processing for various data plane services for different tenants.

### SUMMARY

Systems, methods and computer program products are provided for implementing data plane services in a data center. A data center includes one or more central controllers, such as, e.g., a cloud orchestration controller and a software-defined networking controller for managing hosts in the data center. Hosts may have one or more tenants, which may have one or more virtual machines. A tenant may request data plane services from the central controller for a particular virtual machine. The data plane services provide packet processing functionality for the particular virtual machine. The central controller instantiates a service process, such as, e.g., a service virtual machine, at the tenant for performing the packet processing.

Advantageously, tenant-specific data plane services are provided. Instead of implementing a centralized instance of the data plane service for the entire data center, the service process is introduced for the particular VM at the tenant. This provides easy scalability with additional workload at the host. In addition, service processes are easily manageable using the centralized controller.

These and other advantages will be apparent to those of ordinary skill in the art by reference to the following detailed description and the accompanying drawings.

### BRIEF DESCRIPTION OF THE DRAWINGS

FIG. 1 shows a high-level overview of a data center;

FIG. 2 shows a detailed view of the data center with process instances for a data plane service being implemented at hosts of the data center;

FIG. 3A shows traffic flow for a data plane service requiring mirroring of traffic between the data plane service and tenant virtual machine;

FIG. 3B shows traffic flow for a data plane service requiring chaining traffic from the data plane service to the tenant virtual machine;

FIG. 3C shows traffic flow for a data plane service requiring splitting traffic from a data plane service to a plurality of tenant virtual machines;

FIG. 4 shows a flow diagram of a method for providing data plane services in a data center; and

FIG. 5 depicts a high-level block diagram of a computer for providing data plane services in a data center.

### DETAILED DESCRIPTION

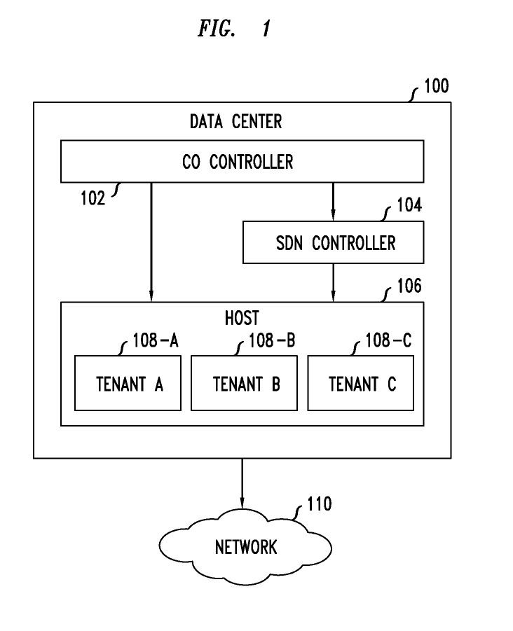

FIG. 1 shows an illustrative data center 100 in accordance with one or more embodiments. Data center 100 may be connected to other data centers, servers or other entities via communications network 110 using one or more network elements (not shown), such as, e.g., routers, switches, firewalls, etc. Network 110 may include a local area network (LAN), a wide area network (WAN), the Internet, a telecommunications network, or any other suitable network.

Data center 100 includes one or more centralized controllers, such as, e.g., cloud orchestration (CO) controller 102 for managing resources of the data center and software-defined network (SDN) controller 104 for managing network virtualization with the data center. In particular, CO controller 102 configures and manages data center resources on a per tenant basis and SDN controller 104 configures and manages all switching elements of the data center for routing tenant traffic within the data center network. Data center 100 also includes one or more hosts 106. It should be understood that data center 100 may include any number of hosts 106. Each host 106 of data center 100 may host one or more tenants 108-A, 108-B, and 108-C, collectively referred to as tenants 108. Tenants 108 represent applications belonging to a customer, user, or other entity having a collection of virtual or native machines that are managed as a single entity. While tenants 108 are shown as tenants 108-A, 108-B, and 108-C, host 106 may host any number of tenants.

Generally, network elements in data center 100 can be classified into three logical components: the control plane, the data plane (also known as the forwarding plane), and the management plane. The control plane executes different signaling and/or routing protocols and provides all the routing information to the data plane. The data plane makes decisions based on this information and performs operations on packets. The management plane manages the control and data planes. In a data center, there is a growing demand for various data plane services for already deployed tenant virtual machines (VMs). Exemplary data plane services include mirroring traffic (e.g., deep packet monitoring, security applications), chaining traffic where traffic is first routed to the data plane service for processing before being routed to the tenant VM (e.g., network address translation, firewall, content-based filtering, transmission control protocol (TCP) proxy), splitting traffic where traffic is routed to the data plane service, which splits the traffic between two or more tenant VMs (e.g., content-based load balancing), etc.

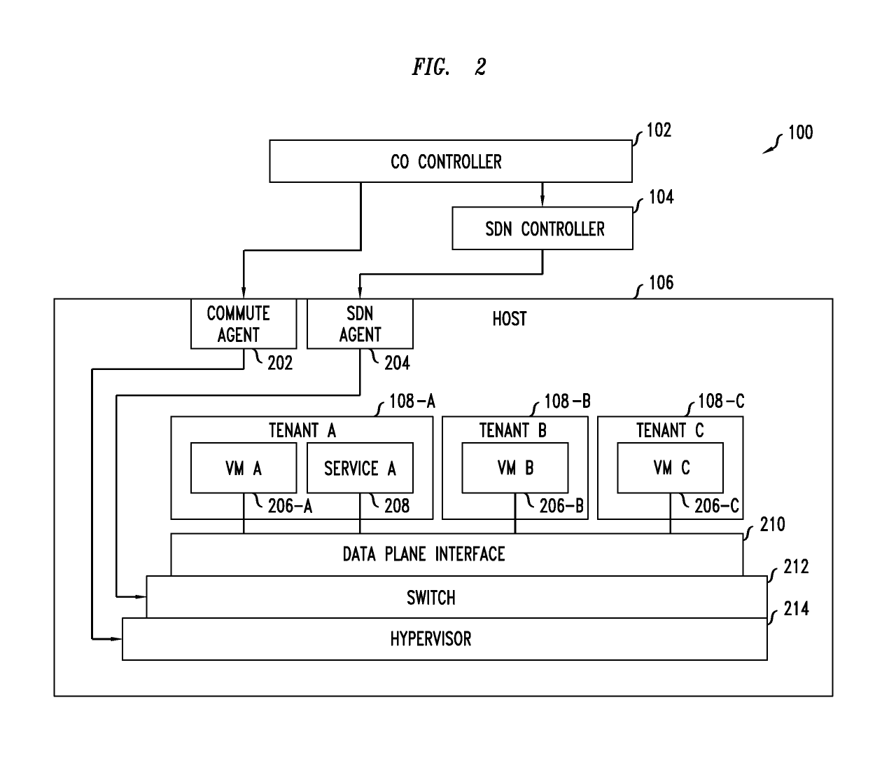

FIG. 2 shows a detailed view of host 106 in data center 100 in accordance with one or more embodiments. Host 106 includes compute agent 202 for interfacing with CO controller 102 for tenant VM configuration and SDN agent 204 for interfacing with SDN controller 104 for switch configuration. Compute agent 202 and SDN agent 204 run on hypervisor 214 of host 106. CO controller 102 and SDN controller 104 control host 106 via compute agent 202 and SDN agent 204.

Tenants 108-A, 108-B, and 108-C of host 106 may include one or more tenant VMs 206-A, 206-B, and 206-C, respectively, collectively referred to as VMs 206. VMs 206 are software-based emulations of a physical machine (e.g., computer). VMs 206 of host 106 communicate with each other and with compute agent 202 and SDN agent 204 via switch 212. In one embodiment, switch 212 is implemented in software to manage traffic of host 106. Switch 212 may run in hypervisor 214 of host 106 or in one or more VMs 206 of host 106. All communication to and from VMs 206 passes through switch 212. Configuration of switch 212 is managed by CO controller 102 and/or SDN controller 104.

Data center 100 enables tenant specific customized data plane services by instantiating data plane services at host 106. It is assumed that data center 100 is using distributed switching and routing by configuring switches (e.g., switch 212) of the hosts 106 using one or more of the centralized controllers (i.e., CO controller 102 and SDN controller 104). Data plane services for a tenant are specified or requested by the tenant to CO controller 102. CO controller 102 then instantiates one or more service processes, such as, e.g., service A 208 for VM A 206-A belonging to tenant A 108-A, in data plane interface 210 for implementing the data plane services specified by the tenant. Service processes may be instantiated in different ways, such as, e.g., full hardware virtualization (e.g., such as VMs), lightweight operating system-level virtualization (e.g., such as Linux/Docker containers), or even as regular processes.

Service A 208 may be instantiated by CO controller 102 for running data plane specific code for the specified data plane service. Service processes are only applicable to its tenant VMs and visible at the host hypervisor. Service A 208 may include a configuration of switch 212 (e.g., mirroring traffic for monitoring), a process instance on hypervisor 214, or any other type of service process. In one embodiment, service A 208 is a service VM for supporting generalized packet processing functionality for the tenant VM 206-A. Upon instantiation of service A 208, CO controller 102 (and/or SDN controller 104) also configures switch 212 for routing traffic in accordance with the specified data plane service. CO controller 102 (and/or SDN controller 104) configures service specific interfaces to tenants 108 so they can use the data plane services (e.g., add/update firewall rules or snort rules). For example, tenant 108-A may supply firewall policies and CO controller 102 and/or SDN controller 104 will configure the data plane to implement the policies for the tenant traffic.

Advantageously, data plane service 208 and tenant VM 206-A are bundled together on the same host 106. This provides easy scalability with additional workload at host 106. This also makes service processes (e.g., service A 208) easily manageable using CO controller 102 and/or SDN controller 104. In addition, tenant traffic is intelligently service chained through the service processes, keeping traffic flow within host 106 as much as possible. This reduces east-west traffic in data center 100 and enables dynamic service introduction.

Consider, for example, the scenario where tenant A 108-A requests firewall processing from CO controller 102. Instead of implementing a centralized instance of a firewall for all of data center 100, a firewall instance is introduced for one or more VMs belonging to tenant A 108-A (i.e., for VM A 206-A). CO controller 102 instantiates a service VM configured with firewall logic according to rules of tenant A 108-A. CO controller 102 also configures switch 212 to chain traffic of the tenant VM through the service VM for performing firewall data plane services. Each firewall instance is configured to be in the path of the tenant's traffic flow and handles the traffic volume for the host VM only. In this way, the firewall service is distributed over data center 100 and scales out with the number of hosts.

Two technological advances are leveraged to keep up with the extra processing overhead introduced by the custom data plane services: high performance user space packet processing (e.g., data plane development kit) and the increasing number of cores per host. High performance user space packet processing may be used to prevent bottlenecks for packet processing at high speeds. Examples of high performance user space packet process include, e.g., Data Plane Development Kit (DPDK), NetMap, PF_Ring, etc. For example, switch 212 may be built using DPDK and run at the user space to allow switch 212 to handle very high packet throughput using a single dedicated core. Tenant VMs 206 are assumed to be unmodified, so they need not be aware of any DPDK installation. This not only avoids costly modifications for tenants, but also circumvents any security issue that may arise due to packet buffer space sharing between a guest VM and the host hypervisor. However, the service process 208, being part of the infrastructure and created on a per tenant basis, can enjoy the high throughput by using DPDK. As such, in one embodiment, service processes 208 are created using DPDK so that packets can be directly copied into the service process' memory (i.e., memory mapped I/O) for data plane services. The packet processing code is developed using application programming interfaces (APIs) provided by DPDK to exploit the high performance user space packet processing.

The architecture of data center 100, however, makes centralized decision on data plane processing more challenging. For example, consider the example where a tenant's firewall rule allows a maximum of N transmission control protocol (TCP) sessions into the tenant VMs. Since each VM is front-ended with its own firewall, the challenge is how to ensure that no more than N TCP sessions are allowed into the VM pool of the tenant. In order to sync up any global states of service processes of a same tenant, service processes of a same tenant need to communicate with each other.

In one embodiment, a distributed synchronization protocol may be leveraged to synchronize different data plane instances. Any suitable protocol may be employed, such as, e.g., border gateway protocol (BGP). The distributed synchronization protocol either runs at hypervisor 214 of host 108 or at a service process (e.g., service A 208).

In another embodiment, a central approach is employed to leverage a central controller (e.g., CO controller 102 and/or SDN controller 104) to coordinate synchronization among multiple service instances. The compute agent 202 and/or SDN agent 204 collect service specific data of service processes and send it to CO controller 102 and/or SDN controller 104, respectively. CO controller 102 and/or SDN controller 104 run service specific synchronization logic to sync up the distributed state, and then inform the service processes using compute agent 202 and/or SDN agent 204, respectively, at the host. The use of CO controller 102 and/or SDN controller 104 to propagate and maintain the distributed state simplifies the processing and facilitates more real-time control. In addition to the logically centralized coordination, the architecture of data center 100 is able to support distributed or hybrid methods.

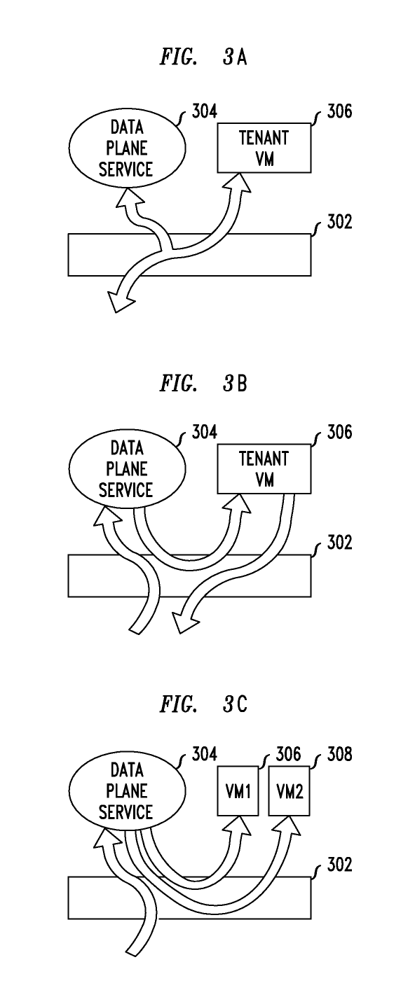

FIGS. 3A, 3B, and 3C illustratively depict traffic flow for various data plane services in accordance with one or more embodiments. Data plane services in FIGS. 3A, 3B, and 3C include services for mirroring, chaining, and splitting traffic. It should be understood that other types of data plane services and traffic routing may also be employed in various embodiments.

FIG. 3A shows a block diagram where traffic is routed by switch 302 in accordance with data plane service 304. In FIG. 3A, data plane service 304 requires mirroring of traffic. Switch 302 is configured to mirror traffic to data plane service 304 for processing and to tenant VM 306. All traffic passes through switch 302 for routing. One example of a data plane service requiring mirroring includes policy-based traffic mirroring, where packet dumps are collected and aggregated at flow-level granularity. Other examples of a data plane service 304 which requires mirroring traffic include monitoring, security applications, intrusion detection, etc.

FIG. 3B shows a block diagram where traffic is routed by switch 302 for a data plane service 304 which requires chaining. Switch 302 is configured to route traffic first to data plane service 304 for processing. Traffic is then routed from data plane service 304 to tenant VM 306. One example of a data plane service requiring chaining includes content-based filtering, where hypertext transfer protocol (HTTP) requests are blocked or allowed from a web server based on black- or white-listed uniform resource locator (URL). Other examples of a data plane service which requires chaining traffic include network address translation, firewall, intrusion prevention, etc.

FIG. 3C shows a block diagram where traffic is routed by switch 302 for a data plane service 304 which requires splitting traffic. Switch 302 is configured to route traffic first to data plane service 304 for processing. Traffic is then routed between tenant VM 306 and tenant VM 308 by data plane service 304. One example of a data plane service requiring splitting includes content-based load balancing, where HTTP requests are load balanced among multiple co-located VMs based on the requested URLs.

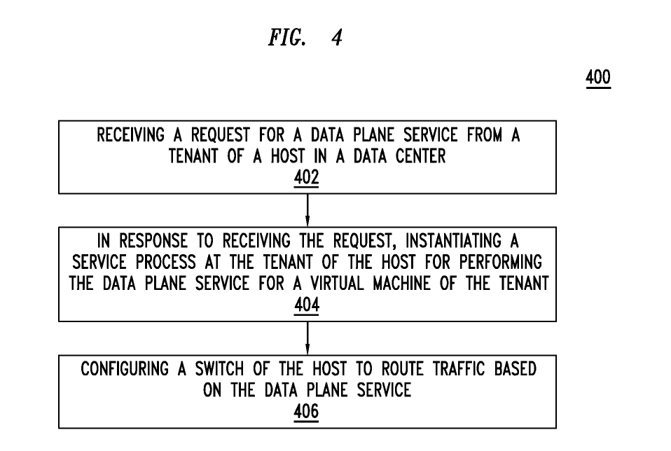

FIG. 4 shows a flow diagram of a method 400 for data plane processing in a data center, in accordance with one or more embodiments. In block 402, a request is received for a data plane service from a tenant of a host in a data center. The request is received by a central controller of the data center, such as CO controller 102.

In block 404, in response to receiving the request, a service process is instantiated at the tenant of the host for performing the data plane service for a virtual machine of the tenant. The service process is instantiated at the hypervisor of the host by the central controller of the data center. The service process supports packet processing functionality for the VM for the requested data plane service. The service process may include, e.g., a configuration of a switch of the host, a process instance on the hypervisor of the host, a service VM, or any other type of service process. The service process is only visible to its associated VM.

In block 406, the switch of the host is configured to route traffic based on the data plane service. All traffic between VMs passes through the switch. The switch may run in the hypervisor of the host. In one embodiment, the switch is implemented in software using high performance user space packet processing, such as, e.g., DPDK. The switch is configured by the central controller of the host according to the data plane service. For example, the switch may be configured for mirroring, chaining, splitting, etc. traffic based on the data plane service.

In one embodiment, a distributed synchronization protocol, such as, e.g., BGP, is employed to synchronize data plane instances. In another embodiment, the central controller (e.g., CO controller 102, SDN controller 104) of the data center is used to coordinate synchronization states of service processes. The distributed synchronization protocol runs in the hypervisor of the host and collects and sends service specific data for each service process to the central controller. The central controller synchs the data and sends a global state to the service processes.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 4. Certain steps of the methods described herein, including one or more of the steps of FIG. 4, may be performed by a server or by another processor in a network-based cloud-computing system. Certain steps of the methods described herein, including one or more of the steps of FIG. 4, may be performed by a client computer in a network-based cloud computing system. The steps of the methods described herein, including one or more of the steps of FIG. 4, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

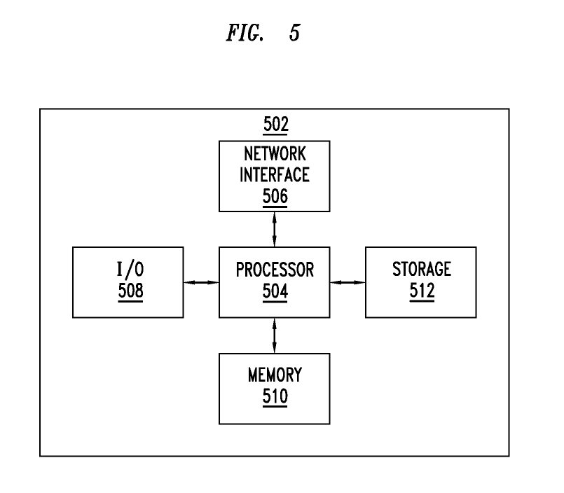

A high-level block diagram of an example computer that may be used to implement systems, apparatus, and methods described herein is depicted in FIG. 5. Computer 502 includes a processor 504 operatively coupled to a data storage device 512 and a memory 510. Processor 504 controls the overall operation of computer 502 by executing computer program instructions that define such operations. The computer program instructions may be stored in data storage device 512, or other computer readable medium, and loaded into memory 510 when execution of the computer program instructions is desired. Thus, the method steps of FIG. 4 can be defined by the computer program instructions stored in memory 510 and/or data storage device 512 and controlled by processor 504 executing the computer program instructions. For example, the computer program instructions can be implemented as computer executable code programmed by one skilled in the art to perform the method steps of FIG. 4. Accordingly, by executing the computer program instructions, the processor 504 executes the method steps of FIG. 4. Computer 502 may also include one or more network interfaces 506 for communicating with other devices via a network. Computer 502 may also include one or more input/output devices 508 that enable user interaction with computer 502 (e.g., display, keyboard, mouse, speakers, buttons, etc.).

Processor 504 may include both general and special purpose microprocessors, and may be the sole processor or one of multiple processors of computer 502. Processor 504 may include one or more central processing units (CPUs), for example. Processor 504, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 502.

Any or all of the systems and apparatus discussed herein, including systems 100 of FIGS. 1 and 2, may be implemented using one or more computers such as computer 502.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing data plane services in a data center, comprising:
receiving a request for a data plane service from a tenant of a host in the data center; and
in response to receiving the request, instantiating a service process at the host, the service process providing the data plane service for a virtual machine of the tenant.

2. The method of claim 1, further comprising:
configuring a switch of the host to route traffic based on the data plane service.

3. The method of claim 2, wherein all communication between virtual machines of the tenant passes through the switch.

4. The method of claim 1, further comprising:
synchronizing a state of the service process with other service processes of the host.

5. The method of claim 4, wherein synchronizing comprises:
employing a distributed synchronization protocol to synchronize the state of the service process with other service processes of the host.

6. The method of claim 4, wherein synchronizing comprises:
coordinating synchronization using a central controller of the data center.

7. The method of claim 1, wherein instantiating is by a central controller of the data center.

8. The method of claim 1, wherein data plane services include at least one of mirroring, chaining, and splitting traffic.

9. The method of claim 1, wherein the service process includes a service virtual machine.

10. A computer readable medium storing computer program instructions for providing data plane services in a data center, which, when executed on a processor, enable the processor to perform operations comprising:
receiving a request for a data plane service from a tenant of a host in the data center; and
in response to receiving the request, instantiating a service process at the host, the service process providing the data plane service for a virtual machine of the tenant.

11. The computer readable medium of claim 10, the operations further comprising:
configuring a switch of the host to route traffic based on the data plane service.

12. The computer readable medium of claim 10, the operations further comprising:
synchronizing a state of the service process with other service processes of the host.

13. The computer readable medium of claim 10, wherein data plane services include at least one of mirroring, chaining, and splitting traffic.

14. An apparatus comprising:
a processor; and
a memory to store computer program instructions for providing data plane services in a data center, the computer program instructions when executed on the processor cause the processor to perform operations comprising:
receiving a request for a data plane service from a tenant of a host in the data center; and
in response to receiving the request, instantiating a service process at the host, the service process providing the data plane service for a virtual machine of the tenant.

15. The apparatus of claim 14, the operations further comprising:
configuring a switch of the host to route traffic based on the data plane service.

16. The apparatus of claim 15, wherein all communication between virtual machines of the tenant passes through the switch.

17. The apparatus of claim 14, the operations further comprising:
synchronizing a state of the service process with other service processes of the host.

18. The apparatus of claim 17, wherein the synchronizing operation comprises:
employing a distributed synchronization protocol to synchronize the state of the service process with other service processes of the host.

19. The method of claim 17, wherein the synchronizing operation comprises:
coordinating synchronization using a central controller of the data center.

20. The apparatus of claim 14, wherein instantiating is by a central controller of the data center.
